(19) United States
(12) Patent Application Publication
(10) Pub. No.: US 2005/0162272 A1
(43) Pub. Date: Jul. 28, 2005

(54) Simplified A.M. transmitter for lost persons, especially children and hunters

(76) Inventor: Ernest F. Gossy, Hollywood, FL (US)

Correspondence Address: ERNEST F. GOSSY, 2005 N. 49 Av., Hollywood, FL, 33021, US

(21) Appl. No.: 10/930,479

(22) Filed: Sep. 1, 2004

Related U.S. Application Data
(60) Provisional application No. 60/538,784, filed on Jan. 26, 2004.

(51) Int. Cl. G08B 1/08

(52) U.S. Cl. 340/539.13; 340/573.4

(57) ABSTRACT

The Emergency Locator Transmitter (ELT) is a uniquely designed, simple to use, personal locator, which could be activated under circumstances in which the carrier becomes incapacitated. This feature makes it useful for children, the elderly or travelers. The size (5 and ½ inches long by ⅝″ wide) makes it small enough for a child to carry or wear daily. A detailed instruction book would not be necessary, only a short memorandum informing the user of how to turn it on and change the battery. The battery to be used will provide 5 or more watts of power. As an AM transmitter, it is not as limited as an FM unit would be.

### BACKGROUND

As an airline pilot for many years, I became familiar with the E.L.T. used on emergency life rafts with AM (amplitude modulation),and believe that it would be a valuable piece of equipment to have when in the forest or remote locations because an AM transmitter will travel greater distance than an FM transmitter. I used a GPS device while hunting and found it unusable in a forest.

The E.L.T., as I propose, would be about the size of a ball point pen, operate on one (1) battery and have a flexible wire antenna inside the pointed end. The pocket clip would also serve as an off-on switch. A built-in timer would activate the transmitter if not reset each four (4) hours. This would serve as a safety feature if the person was incapacitated in any way and unable to turn it on. The frequency would be assigned by the Federal Communications Commission (FCC).

The unit is to be made of plastic like a ball point pen, but large enough around to hold one (1) battery, the transmitter and the antenna.

A specific color is not significant, but bright yellow or orange is recommended for ease of location by the user in unlit or dimly lit conditions.

### DRAWINGS

### See Separate Pages

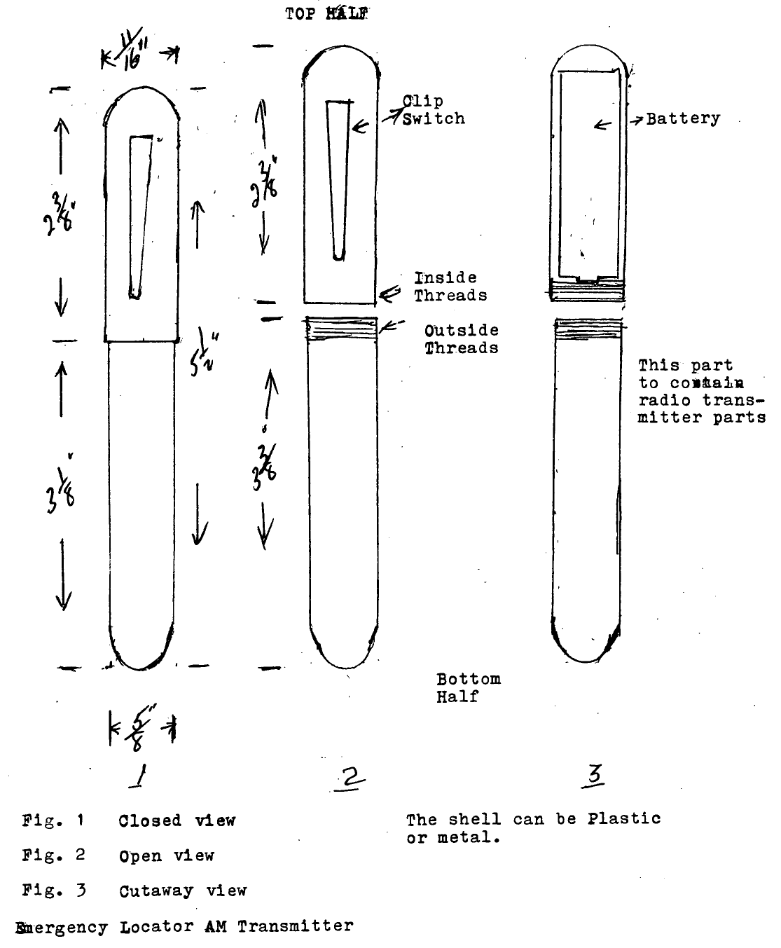

FIG. 1- A detailed drawing of the E.L.T.: overall, external, closed view

FIG. 2- A detailed drawing of the E.L.T.: overall, external, open view

FIG. 3- An internal view of E.L.T.: location of components

### DETAILED DESCRIPTION

1. Plastic hollow barrel as used by ball point pen manufacturers.

2. Exterior of upper or battery end should be two and three quarters inches (2 and ¾″) long by eleven sixteenths inches (11/16″) wide, half rounded end. Clip serves as an on-off switch and would be one and seven-eighths inches (1 and ⅞″) long and one-eighth inch (⅛″) wide. Inside diameter would be one-eighth inch (⅛″) less than outside. Lower three-eighths inch (⅜″) is threaded inside to mate with lower half of unit.

3. Bottom half overall length would be three and one-eighth inches (3 and ⅛″) long. Adjoining end threaded outside for three-eighths inch (⅜″) to mate with top half. Outside diameter nine-sixteenths inch (9/16″), inside diameter seven-sixteenths inch (7/16″).

4. A micro chip assembly of necessary parts to be purchased from an analog transmitter manufacturing company.

5. Assembly and testing to be done in Florida.

6. At present, there are similar products on the market; however none resemble the E.L.T. in terms of size or cost.

7. The E.L.T. could be used by anyone because of its simplicity.

8. The power output of the transmitter would be determined by the supplier. The miniaturization of all transmitter parts will be requested from the supplier to reduce battery drain and provide maximum wattage output.

### CLAIM

### Personal Emergency Locator Transmitter

Emergency locator transmitters already exist on life rafts installed in aircraft. These are large and cumbersome and not suitable for a child to take to school or play. They are not appropriate for a dressed woman, child or a hunter because of size and weight.

The unit I propose would be small enough to fit in a shirt pocket or a purse or clipped onto a child's clothing. Weight target is five (5) ounces or less.

The size, weight, simplicity and ease of manufacture (to minimize the cost so that everyone could have one), is the heart of my claim. Lost or kidnapped children would be greatly reduced.

Hunters, hikers and explorers would not have to study a twenty (20) page booklet in order to learn how to use it like a GPS. It would also operate where a GPS won't.

Being able to turn itself on makes it a unique safety feature for incapacitated persons.

1. A small, lightweight, portable personal AM emergency locator transmitter that can turn itself on if the person is incapacitated.
